(19) United States
(12) Patent Application Publication
(10) Pub. No.: US 2013/0230789 A1
(43) Pub. Date: Sep. 5, 2013

(54) FUEL CELL ASSEMBLY WITH ANTI-CLOCKING FEATURES AT THE ENDS OF THE CELL STACK ASSEMBLY

(71) Applicants: Christopher John Carnevale, Vernon, CT (US); Jeffrey G. Lake, Vernon, CT (US); Michael D. Harrington, Windsor Locks, CT (US)

(72) Inventors: Christopher John Carnevale, Vernon, CT (US); Jeffrey G. Lake, Vernon, CT (US); Michael D. Harrington, Windsor Locks, CT (US)

(73) Assignee: UTC POWER CORPORATION, South Windsor, CT (US)

(21) Appl. No.: 13/883,898

(22) PCT Filed: Nov. 24, 2010
(86) PCT No.: PCT/US10/57928

§ 371 Date: May 7, 2013

(51) Int. Cl. H01M 8/24

(52) U.S. Cl. CPC H01M 8/2465
USPC 429/470; 429/535

(57) ABSTRACT

An exemplary fuel cell assembly includes a cell stack having a plurality of cells. The cell stack has an outermost plate at each of two opposite ends of the cell stack. An end plate is adjacent the outermost plate at each of the opposite ends. A plurality of anti-rotation members at each of the opposite ends prevent relative movement between the outermost plates and the end plates. The anti-rotation members at each end are at least partially received into the end plate at the corresponding end. The anti-rotation members at each end are only partially received into the outermost plate at the corresponding end without extending through the outermost plate.

### BACKGROUND

Fuel cells use an electrochemical reaction to generate electricity. Typical fuel cell arrangements include a cell stack assembly (CSA) having a relatively large number of individual plates stacked next to each other. There are different kinds of plates within the CSA as known.

One of the challenges associated with fuel cell arrangements is maintaining all of the plates of the CSA in proper alignment during assembly and use. Different arrangements have been proposed for achieving proper alignment between the plates within the CSA. One example proposal is shown in the WO 2010/101541 published patent application. The arrangement in that document includes key members received between adjacent plates to keep them from slipping relative to each other.

Such proposed arrangements address the relative positioning of plates next to each other but the plates within the cell stack have to be specially designed to accommodate the keys. Such proposals also introduce additional components, which can be disadvantageous.

### SUMMARY

An exemplary fuel cell assembly includes a cell stack having a plurality of cells. The cell stack has an outermost plate at each of two opposite ends of the cell stack. An end plate is adjacent the outermost plate at each of the opposite ends. A plurality of anti-rotation members at each of the opposite ends prevent relative movement between the outermost plates and the end plates. The anti-rotation members at each end are at least partially received into the end plate at the corresponding end. The anti-rotation members at each end are only partially received into the outermost plate at the corresponding end without extending through the outermost plate.

An exemplary method of controlling the position of fuel cell stack assembly components relative to end plates on each of two opposite ends of the cell stack assembly includes providing an outermost plate at the opposites ends of the cell stack assembly with a plurality of recesses facing toward the adjacent end plate. Each end plate is provided with a plurality of recesses facing toward the adjacent outermost plate. An anti-rotation member is inserted at least partially into the recesses for preventing relative movement between the outermost plates and the end plates. The anti-rotation members are only partially received into the outermost plate at the corresponding end without extending through the outermost plate.

The various features and advantages of a disclosed example will become apparent to those skilled in the art from the following detailed description. The drawings that accompany the detailed description can be briefly described as follows.

### BRIEF DESCRIPTION OF THE DRAWINGS

FIG. 1 schematically illustrates an example fuel cell assembly.

FIG. 2 is a cross-sectional illustration taken along the lines 2-2 in FIG. 1.

FIG. 3 is a partially exploded view of selected portions of the example of FIG. 1.

### DETAILED DESCRIPTION

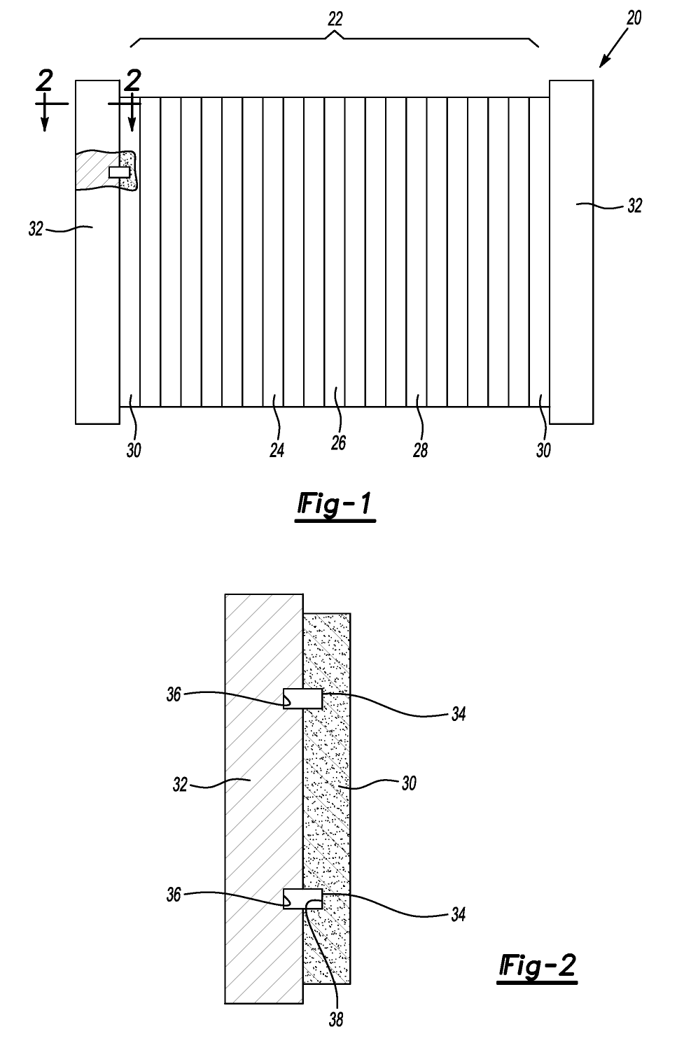

An example fuel cell assembly 20 is schematically illustrated in FIG. 1. A cell stack 22 includes a plurality of plates 24, 26 and 28. As known, the different plates within the cell stack 22 establish individual cells in a known manner. For example, some of the plates are transport plates, some of the plates are membranes, some of the plates are separator plates, etc.

The materials for the plates 24, 26 and 28 within the cell stack 22 and the pressure applied to the assembly 20 is sufficient under most circumstances for maintaining a desired alignment between the plates within the stack 22. The conditions at the outermost or opposite ends of the assembly 20 are different, however. An outermost plate 32 at each of the opposite ends of the cell stack 22 are received against an end plate 32. In most fuel cells, different materials are used for the outermost plates 30 and the end plates 32, respectively. In one example, the outermost plates 30 comprise graphite separator plates. The end plates 32 comprise metal. One example includes steel end plates 32. Another example includes a graphite plate that is a current collector and a pressure plate. The differences between the materials, if any, and the manner in which the outermost plates 30 and the end plates 32 are received against each other presents the possibility for relative movement or rotation between them. This is sometimes referred to as “clocking.”

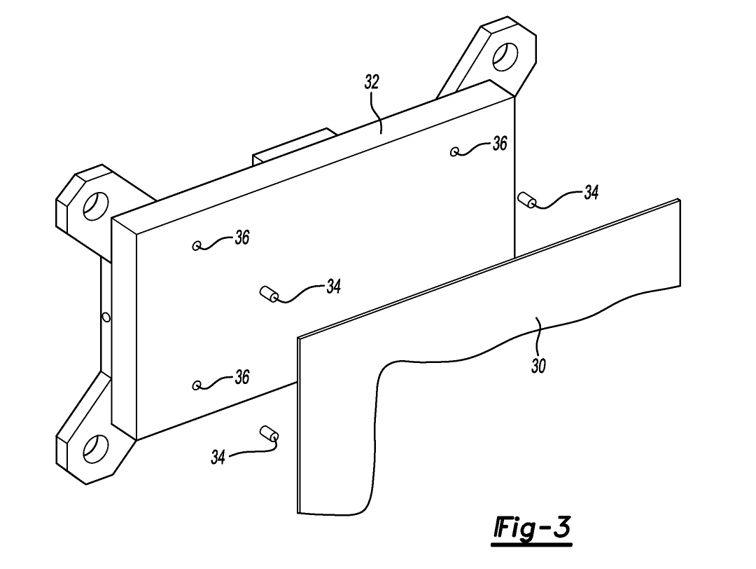

The disclosed example includes an anti-clocking feature that prevents relative rotation or movement between the outermost plates 30 and the end plates 32. As can be appreciated from FIG. 2 and FIG. 3, anti-rotation members 34 are at least partially received into recesses 36 in the end plates 30. The anti-rotation members 34 are also at least partially received into recesses 38 in the outermost plates 30. In this example the anti-rotation members 34 do not extend all the way through the outermost plates 30. They only partially penetrate into the outermost plates 30 as they are received in the recesses 38.

In this example, the anti-rotation members 34 comprise generally cylindrical pins. The anti-rotation members 34 comprise an electrically non-conductive material. The pins are made of a thermoplastic material in one example. One particular example includes polyoxymethylene anti-rotation members 34.

The material selected for the anti-rotation members 34 preferably has some elasticity. The geometry and orientation of the anti-rotation members 34 and the elasticity ensure that any force that would tend to cause relative rotation between the end plates 32 and the outermost plates 30 will tend to deform the anti-rotation members 34 before that force would have any adverse affect on the outermost plates 30. In one example the anti-rotation members 34 are more fragile in the direction of a force that would tend to cause relative rotation between the end plates 32 and the outermost plates 30 (e.g., perpendicular to a length of the pins) would cause the anti-rotation members 34 to break before that force will adversely affect the outermost plates 30.

Configuring the anti-rotation members 34 in a manner that allows for them to respond to a force that would tend to cause rotation between the outermost plates 30 and the end plates 32 allows for maintaining the desired alignment between those components under most circumstances and avoids damage occurring to the outermost plates 30 when a force significant enough to cause such movement occurs.

The anti-rotation members 34 ensure a proper alignment between the outermost plates 30 and the end plates 32. The interface between these two plates does not otherwise provide a sufficiently reliable placement or relative orientation between those components. Maintaining a desired alignment between the outermost plates 30 and the end plates 32 tends to prevent any misalignment between other plates within the south stack 22 because any relative rotary movement or clocking within a cell stack assembly typically includes movement at the end of the stack. By preventing movement at the end of the stack, additional movement at the next interface moving inward toward a center of the south stack 22 is preventable.

Part of this invention includes the discovery that maintaining a desired alignment at the outer edges of the cell stack 22 avoids clocking or misalignment throughout the stack 22. The interfaces between the plates 24, 26 and 28 and the typical pressure used to hold the stack 22 together is usually sufficient to keep the plates within the stack 22 aligned with each other. When clocking or relative rotational movement occurs, a plurality of the plates within the cell stack 22 tend to move as a unit because of the characteristics of the interface between them. Therefore, relative movement between an outermost plate 30 and an adjacent end plate 32 tends to result in additional relative movement within the cell stack 22.

The disclosed example provides an efficient way of maintaining alignment throughout the entire cell stack assembly by securing the interface between the outermost plates 30 and the end plates 32 without requiring additional securing members at the interfaces between the plates within the cell stack 22. Therefore, the disclosed example is believed more economical and efficient than other proposed arrangements that require or include fixing members between the plates within the cell stack along with specially designed plates for purposes of maintaining an alignment between the plates at the interfaces between them.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fuel cell assembly, comprising:
a cell stack including a plurality of cells, the cell stack having an outermost plate at each of two opposite ends of the cell stack;
an end plate adjacent the outermost plate at each of the opposite ends; and
a plurality of anti-rotation members at each of the opposite ends for preventing relative movement between the outermost plates and the end plates, the anti-rotation members at each end are at least partially received into the end plate at the corresponding end, the anti-rotation members at each end are only partially received into the outermost plate at the corresponding end without extending through the outermost plate.

2. The fuel cell assembly of claim 1, wherein the outermost plate at each end comprises a graphite separator plate.

3. The fuel cell assembly of claim 1, wherein the end plate comprises a metal pressure plate.

4. The fuel cell assembly of claim 3, wherein the pressure plate comprises steel.

5. The fuel cell assembly of claim 1, wherein the anti-rotation members comprise an electrically nonconductive material.

6. The fuel cell assembly of claim 5, wherein the material comprises polyoxymethylene.

7. The fuel cell assembly of claim 1, wherein the anti-rotation members comprise pins.

8. The fuel cell assembly of claim 1, wherein the anti-rotation members are more fragile than the outermost plates in a direction of a force that would tend to cause relative rotation between one of the outermost plates and an adjacent end plate to allow the anti-rotation members to break responsive to the force before the outermost plate is adversely affected by the force.

9. The fuel cell assembly of claim 1, wherein the anti-rotation members are more flexible than the outermost plates in a direction of a force that tends to cause relative rotation between one of the outermost plates and an adjacent end plate to allow the anti-rotation members to deform responsive to the force before the outermost plate is adversely affected by the force.

10. The fuel cell assembly of claim 1, wherein the end plate comprises a graphite pressure plate.

11. A method of controlling the position of fuel cell stack assembly components relative to end plates on each of two opposite ends of the cell stack assembly, comprising the steps of:
providing an outermost plate at the opposite ends of the cell stack assembly with a plurality of recesses facing toward the adjacent end plate;
providing each end plate adjacent the outermost plate with a plurality of recesses facing toward the adjacent outermost plate; and
inserting an anti-rotation member at least partially into the recesses for preventing relative movement between the outermost plates and the end plates, wherein the anti-rotation members are only partially received into the outermost plate at the corresponding end without extending through the outermost plate.
